(19) United States
(12) Patent Application Publication
(10) Pub. No.: US 2007/0265980 A1
(43) Pub. Date: Nov. 15, 2007

(54) Systems and methods for managing, maximizing and clearing contractually based media assets

(76) Inventor: Mukesh Sehgal, Greenwich, CT (US)

Correspondence Address: MEREDITH & KEYHANI, PLLC, 330 MADISON AVE., 6TH FLOOR, NEW YORK, NY, 10017, US

(21) Appl. No.: 11/434,469

(22) Filed: May 15, 2006

(51) Int. Cl. H04L 9/00

(52) U.S. Cl. 705/59

(57) ABSTRACT

A method for managing, maximizing and clearing media assets, the method comprising the steps of: inputting at least one asset into a title maintenance module; assigning at least one client value relevant to a client; assigning rights information to each asset; searching for at least one asset for a specific time period according to the rights information to provide programming; searching and ensuring rights clearance according to the rights information; and tracking actual usage of the asset.

The present invention relates generally to methods and systems for managing, maximizing and clearing media assets based on contractual rights.

Digital assets may include a wide variety of content including television programming, music, books, video information or other content. Given the ever increasing amount of information available and stored, it has become increasingly difficult to effectively manage such assets. Further, scheduling according content according to rights is a difficult process that may require tracking volumes of contractual information.

By way of example, a television network may have rights to show a certain show only for the year of 2006 and only between the hours of 12 pm and 5 pm. Any scheduling of the television show outside of this time period would be a violation of the contractual rights associated with the contract. While this may seem simple when managing only one show, networks must schedule vast amounts of content over different time zones and schedules. Accordingly, it becomes very difficult to manage content. Further, it is difficult to maximize use of content. For example, if each piece of content costs a flat fee, regardless of the number of times it is used, it would be wise to show this content the most number of times without violating a contract and not having back to back playing of such content.

Another problem with the prior art is that there is not effective management of content based upon attributes that allow for ease of searching. For example, after an event it may be desirable to quickly pull up digital assets for replay. For example, after Hurricane Katrina a television producer may want to obtain clips of other disasters (e.g. Tsunamis, other hurricanes, fires) to compare the devastation. Previously, searching for such content may have been time consuming and based upon humans memory of content. Another example may be content that is suitable for certain times, or dates, of the year. It may be desirable to play “Born on the Fourth of July” on July 4. Tracking content according to attributes can result in greatly maximizing content. It may also be desirable to be able to search for available assets based upon a wide variety of criteria including clearance, talent, deal, territory, restrictions and elements.

Another problem with the prior art, is the inability to track media assets and their associated financials from inception to final use including payments due, invoicing for payments owed, and amortization schedules. Accordingly, the present invention provides a comprehensive system that manages the entire rights value chain including acquisition, development, program planning, ancillary sales and finance. This allows the user to extract the maximum value from a group of media assets.

An original development, be it a film or a television series may require dozens if not hundred of rights clearances for the elements that go into the production—from music to video clips to images—and each of these elements must be tracked. If one expires, the project could be derailed or the media company may be legally exposed. The present invention provides complete deal management, elemental contract management, backend participation support, and a workflow that supports either date driven or even driven events (such as a payment due on delivery of a manuscript). The present invention ensures that your producers are fully aware of key events such as option renewal windows and payments due in or out, as well as permitting finance personnel to expense elements, amortize assets and handle payments according to business rules.

Underutilized assets are also a problem within the art. For example, perhaps your network lacks penetration in the Spanish language market, now the users can license the Spanish language rights to these titles to another media company. The reporting, as in the present invention, permits you to view the rights available to license and any restrictions such as element expirations.

Accordingly, the present invention provides methods and systems to manage, maximize and clear digital assets to extract the greatest value out of these assets while minimizing and eliminating contractual violations.

### SUMMARY OF THE INVENTION

The present invention relates generally to methods and systems for managing, clearing and maximizing media assets.

According to the present invention, a method for managing, maximizing and clearing media assets is disclosed, the method comprising the steps of: inputting at least one asset into a title maintenance module; assigning at least one client value relevant to a client; capturing deal information including the assignment of rights information to each asset; creating financial schedules for the asset; searching for at least one asset for a specific time period according to the rights information to provide programming; searching and ensuring rights clearance according to the rights information; scheduling the content for playout; licensing the content; and tracking actual usage of the at least one asset.

According to another aspect of the present invention, a system for managing, maximizing and clearing media assets is disclosed, the system comprising: an acquisitions module containing asset information associated with at least one media asset; a development module, wherein the development module tracks and manages at least one media asset; a finance module; a distribution module, wherein the distribution module manages content rights associated with at least one media asset; and a program planning module for creating a program containing at least two media assets.

These and other features, aspects and advantages of the present invention will become better understood with reference to the following description and claims.

### BRIEF DESCRIPTION OF THE DRAWINGS

FIG. 1 is according to the present invention;

FIG. 2 depicts a screenshot according to the present invention;

FIG. 3 depicts a screenshot according to the present invention;

FIG. 4 depicts a screenshot according to the present invention;

FIG. 5 depicts a screenshot according to the present invention;

FIG. 6 depicts a screenshot according to the present invention;

FIG. 7 depicts a screenshot according to the present invention;

and

FIG. 8 depicts a flowchart according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

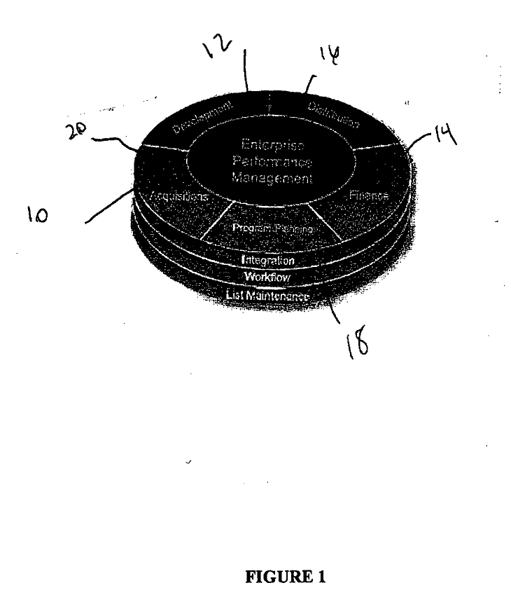

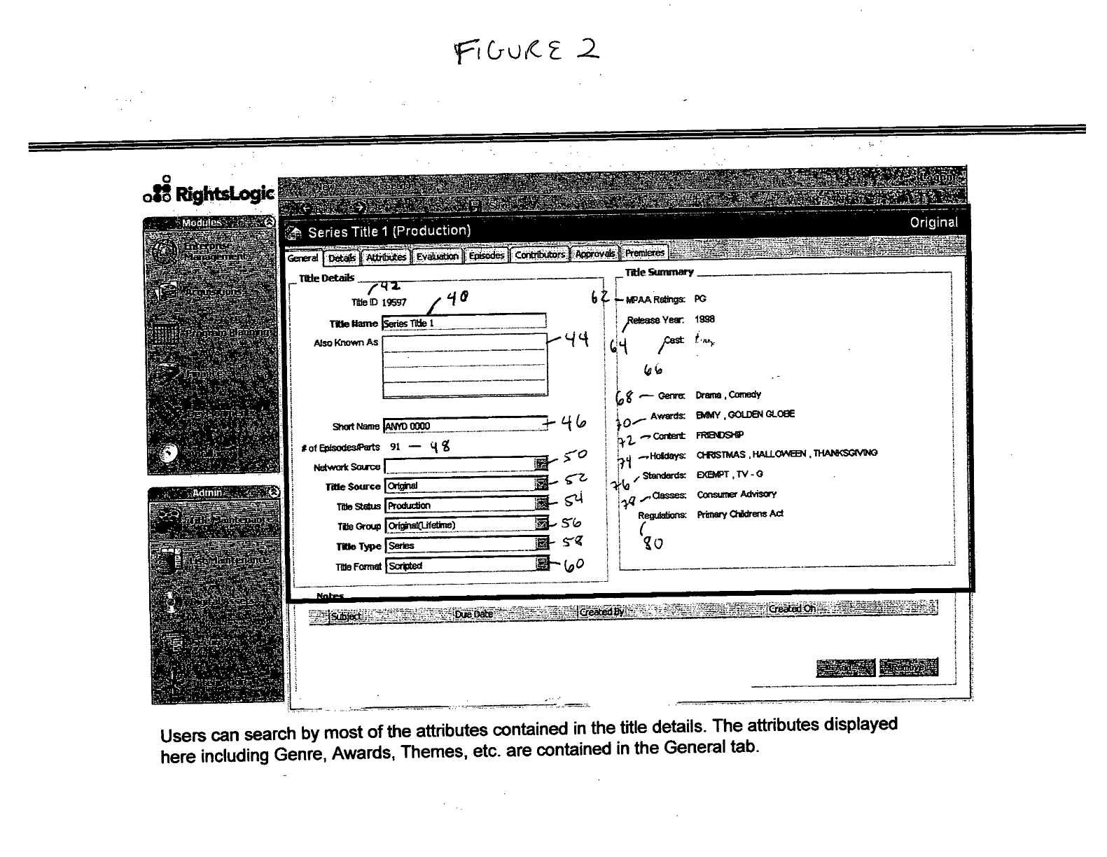

As shown in FIG. 1, the present invention provides a system for managing, maximizing and clearing media assets. The system has includes an acquisitions module (10) containing asset information associated with at least one media asset. There is a development module (12) which tracks and manages at least one media asset. The finance module (14) performs payment functions. The distribution module (16) manages content rights associated with the media assets. The program planning module (18) provides weekly, monthly and quarterly program schedules based upon available media assets.

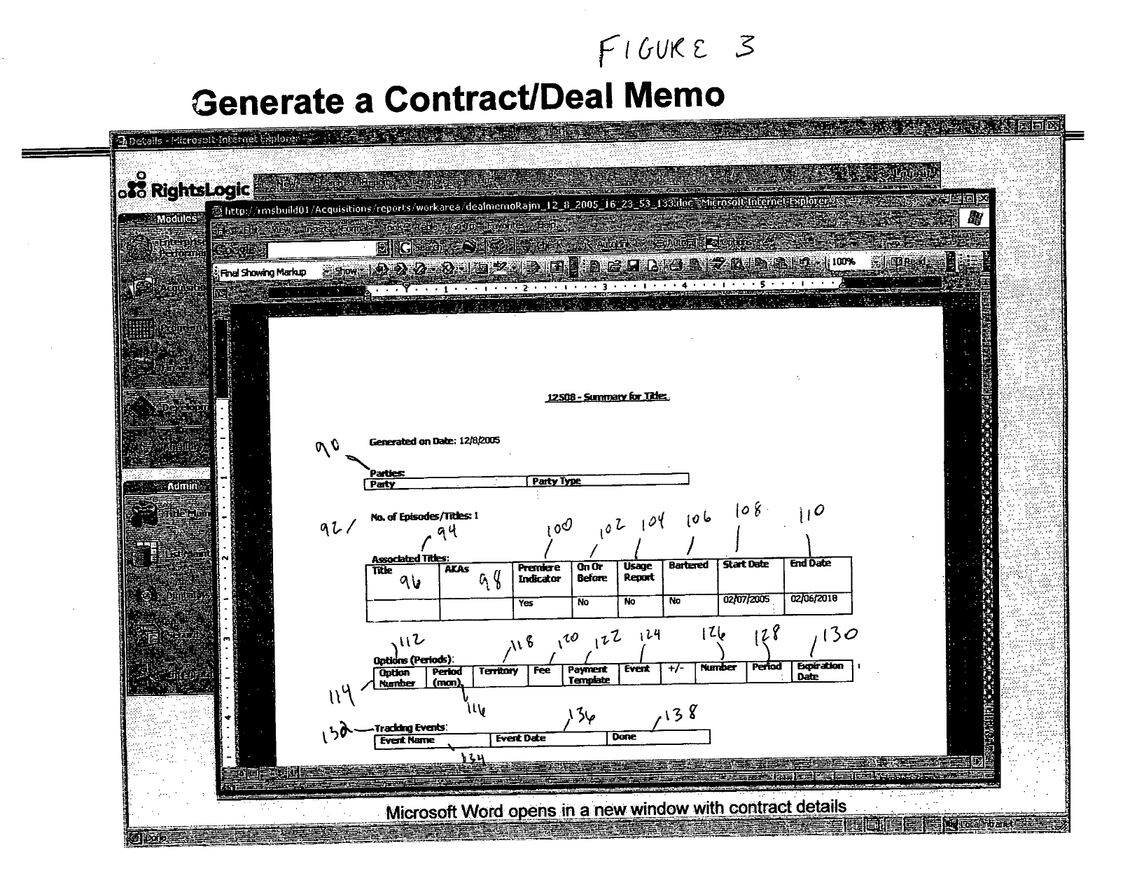

The acquisitions module (10) includes asset information. Asset information may include rights information, business terms and deal values. Business terms may be, for example, warranty clauses, text clauses, payment terms, delivery information, rights granted, license period, license territory, special provisions, residuals, distribution, barter window, editing rights, legal disclaimer. FIG. 2 is a screen shot of the title input for asset information. As shown, a title (40) may be input, having a title ID (42), also known as (44), short name (46), number of episodes (48), network source (50), title source (52), title status (54), title group (56), title type (58), title format (60), MPAA ratings (62), release year (64), cast (66), genre (68), awards (70), content (72), holidays (74), standards (76), classes (78), regulations (80) details. The acquisitions module (10) may also track and manage holdbacks, exclusives, and all other title right details. Asset specific metadata is maintained in a title maintenance module. The title maintenance module allows you to maintain an extensive list of asset attributes. This asset level information gets inherited when the asset is associated with other assets or objects such as deals.

The acquisitions module may include business terms such as rights information including rights, restrictions, promotional, editing, exhibition, elemental, talent, territory, license period, language, networks, exclusivity and hold backs, wherein said development module ensures compliance and payment obligations. Deal values are selected from the group consisting of title details, versions, title attributes, approval requests, notifications, contributors, options, tracking events and rights.

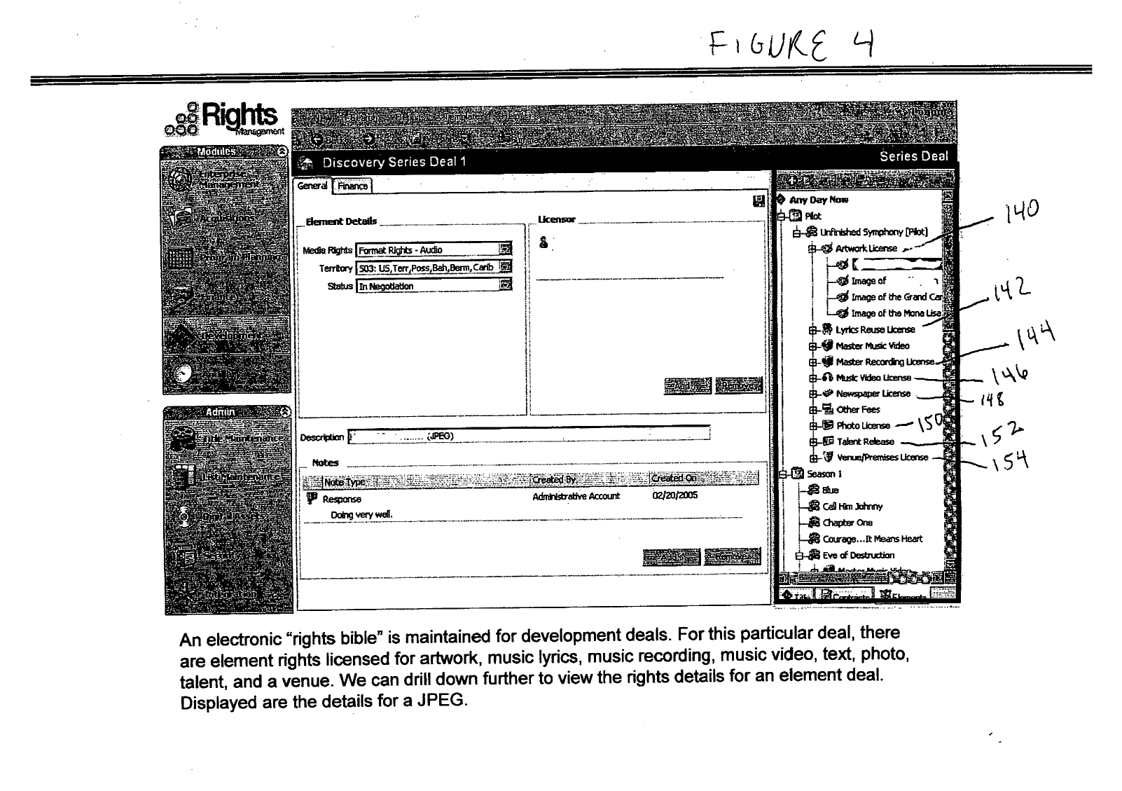

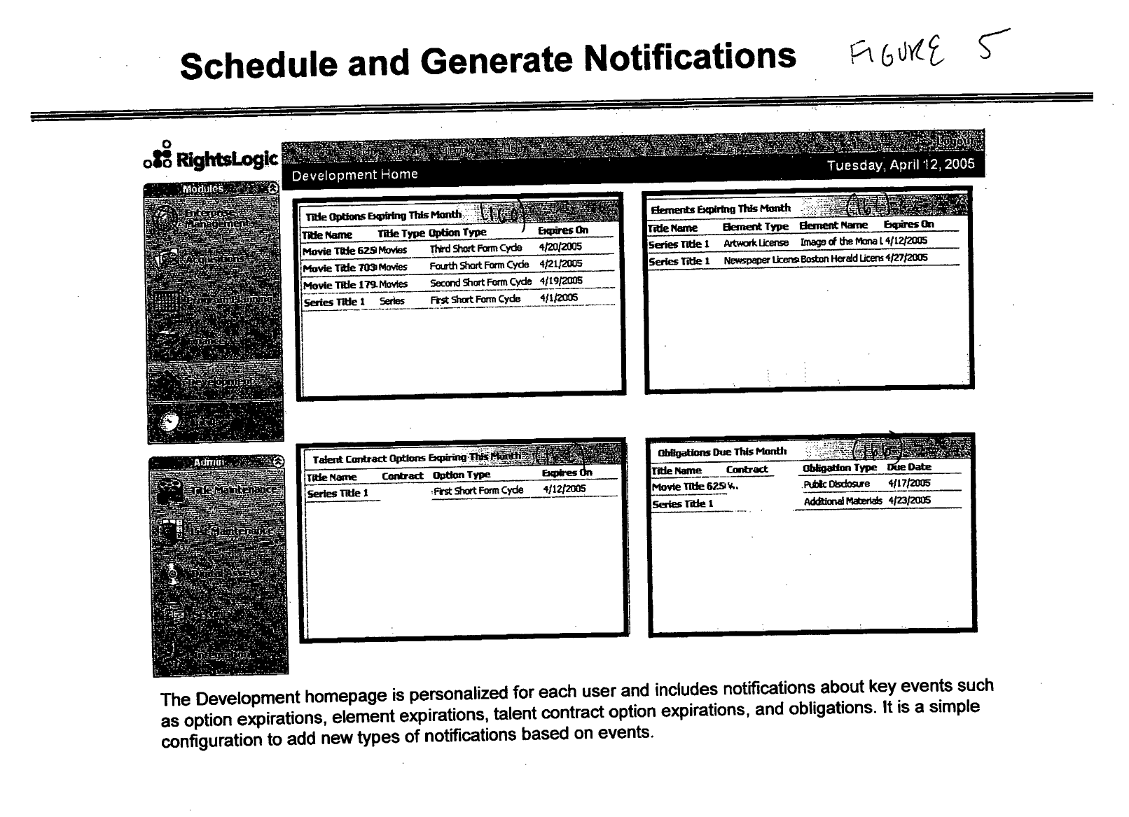

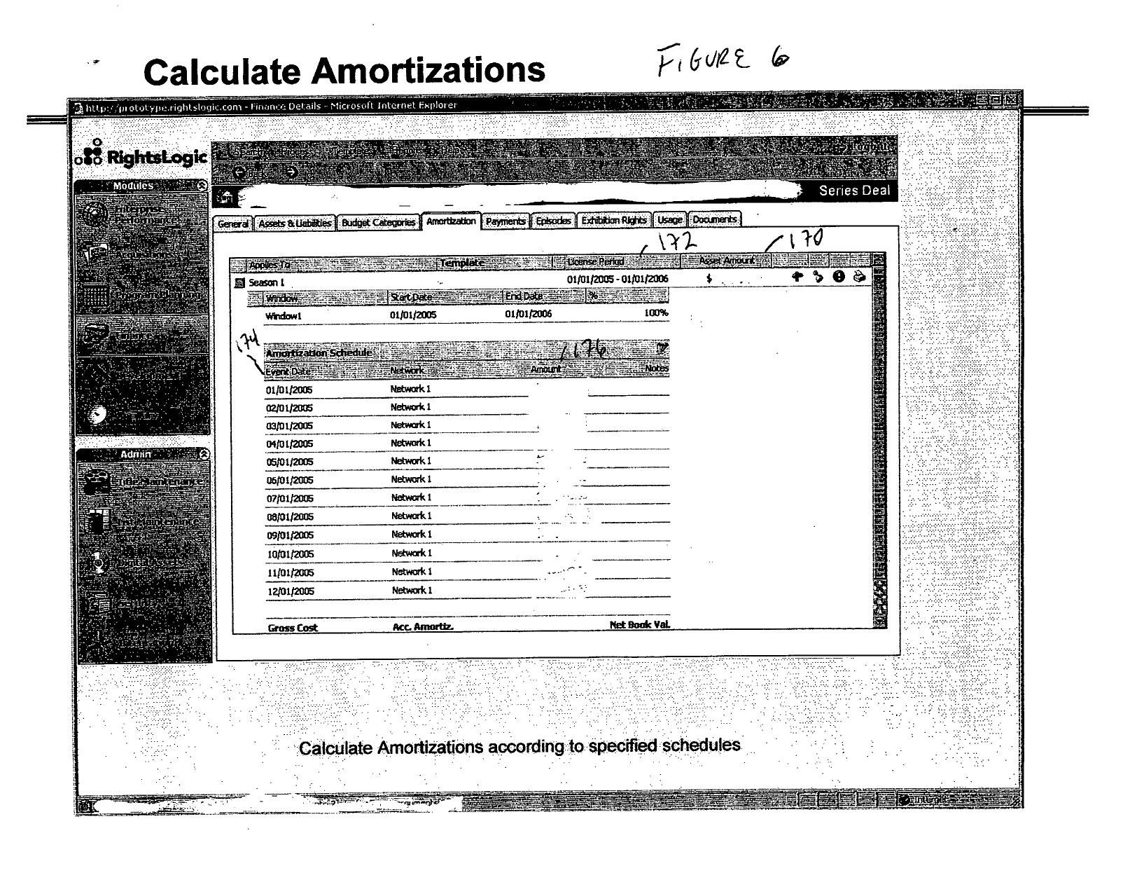

As shown in FIG. 3, the development module (12) may automatically generate contracts using standard business terms and templates. As shown, there may be parties (90), no of episodes (92), associated titles (94), title (96), akas (98), premiere indicator (100), on or before (102), usage report (104), bartered (106), start date (108), end date (110), options (112), option number (114), period (116), territory (118), fee (120), payment template (122), event (124), number (126), period (128), expiration date (130), tracking events (132), event name (134), event date (136), done (138). The development module (12) may also generate a deal memo, as shown in FIG. 4. As shown, for a particular deal there may be element rights licensed for artwork (140), music lyrics (142), music recording (144), music video (146), text (148), photo (150), talent (152) and a venue (154). As shown in FIG. 5, the development module (12) may also schedule milestones by calendar or event. As shown, title options expiring this month (160), elements expiring this month (162), talent contract options expiring this month (164) and obligations due this month (166) may be all be milestones. The distribution module may also track and manage distribution deals and title rights for at least one digital asset. The distribution module may also generate a list of at least one underutilized asset.

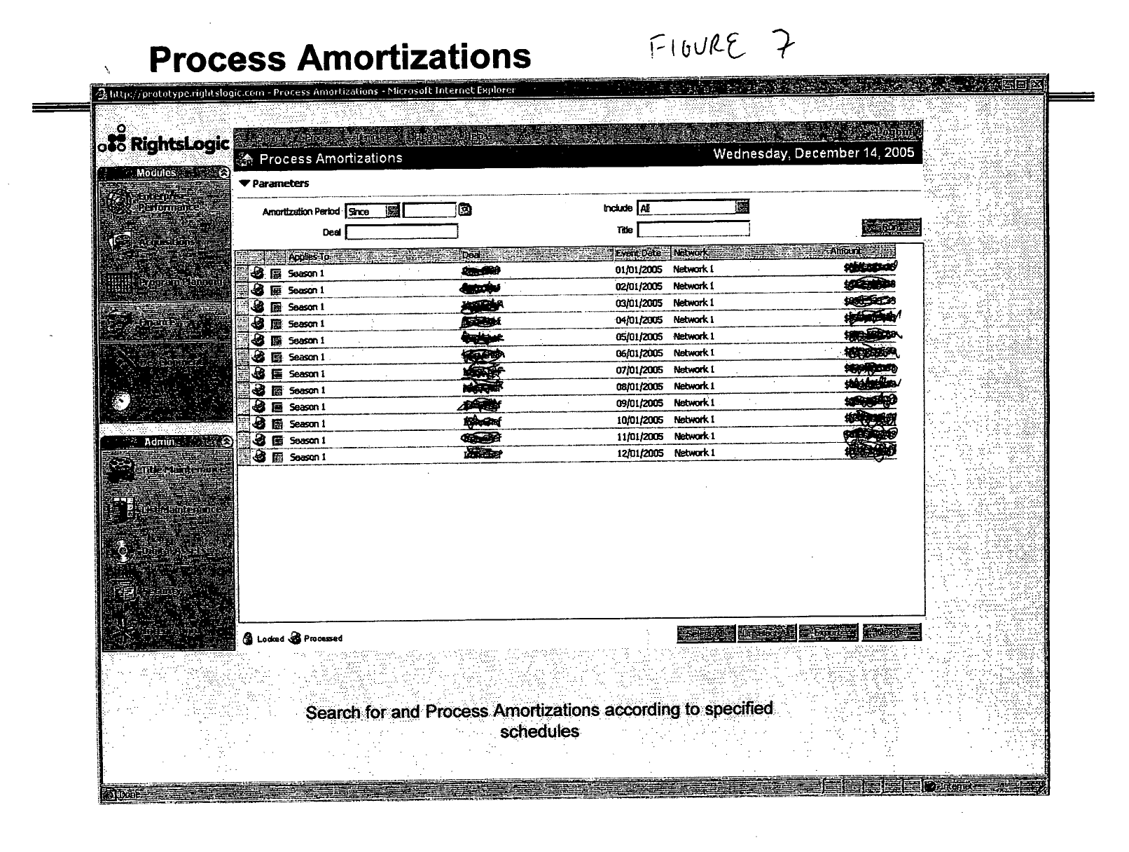

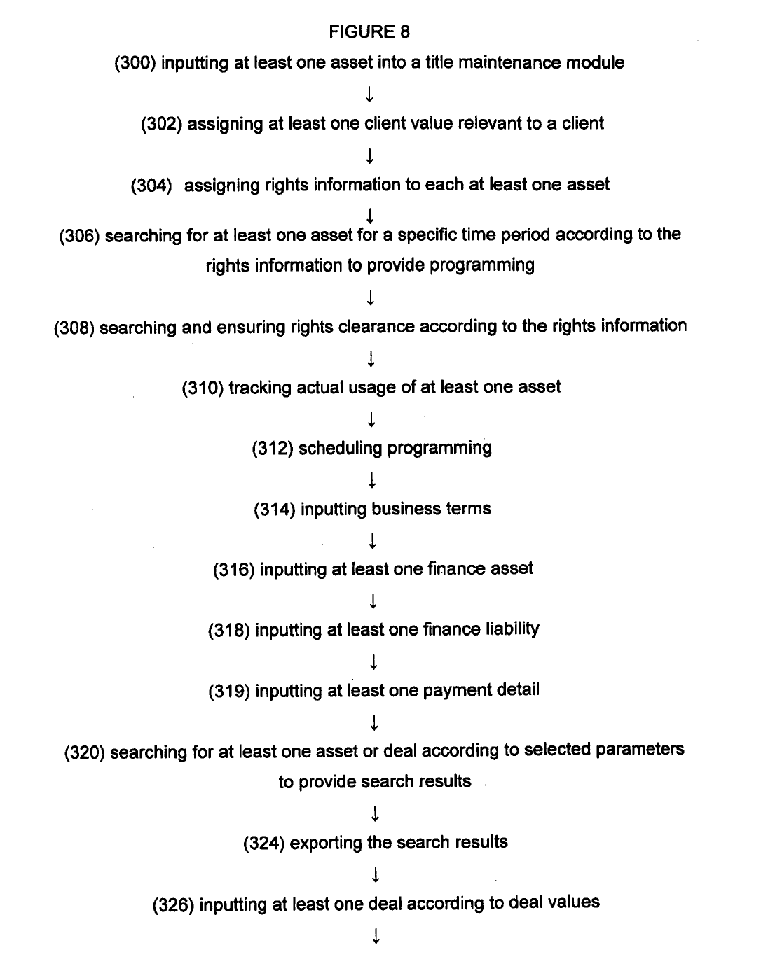

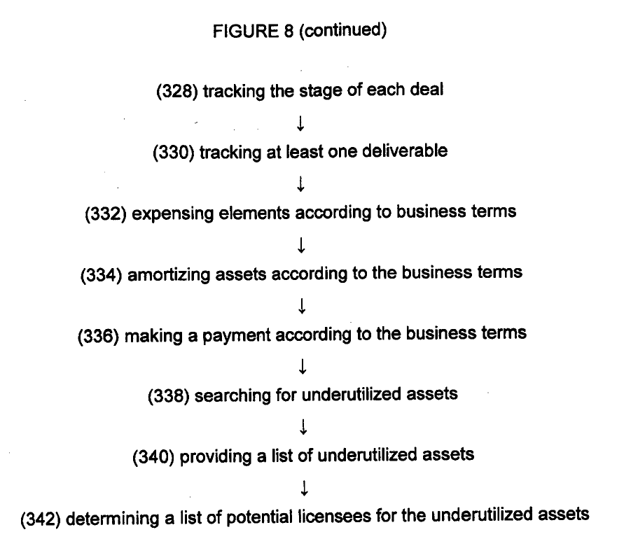

The finance module (14) may track and manage at least one payment associated with at least one digital asset. The finance module (14) may also configure amortization rules-based schedules, as shown in FIGS. 6-7. This may consist of calculating amortizations according to specific schedules. As shown in FIG. 6, a the asset amount (170) may be for a license period (172) of one year (Jan. 01, 2005-Jan. 01, 2005), which may be amortized for a period of one year, requiring monthly payments as an event to be paid on monthly event dates (174) in the amount (176) as shown in the amount (176) column. As shown in FIG. 7, the finance module (14) may also process amortizations payments. The finance module (14) may also integrate with at least one third party financial system to permit financial forecasting.

The program planning module (18) may create at least one program schedule containing at least two digital assets according to the asset information. The program schedule may be determined according to maximized ratings and lower cost. The program planning module (18) may also validate exhibition and territorial rights in real time and manage ancillary content. Ancillary content may be MPAA ratings, script synopsis and cast.

The present invention also envisions a method for managing, maximizing and clearing media assets, the method comprising the steps of: (300) inputting at least one asset into a title maintenance module; (302) assigning at least one client value relevant to a client; (304) assigning rights information to each at least one asset; (306) searching for at least one asset for a specific time period according to the rights information to provide programming; (308) searching and ensuring rights clearance according to the rights information; (310) tracking actual usage of at least one asset; (312) scheduling programming.

The method may further comprise the steps of: (314) inputting business terms; (316) inputting at least one finance asset; (318) inputting at least one finance liability; (319) inputting at least one payment detail; (320) searching for at least one asset or deal according to selected parameters to provide search results; (324) exporting the search results; (326) inputting at least one deal according to deal values; (328) tracking the stage of each deal; (330) tracking at least one deliverable; (332) expensing elements according to business terms; (334) amortizing assets according to the business terms; (336) making a payment according to the business terms; (338) searching for underutilized assets; (340) providing a list of underutilized assets; and (342) determining a list of potential licensees for the underutilized assets.

The rights information may be selected from the group consisting of rights, restrictions, promotional, editing, exhibition, elemental, talent, territory, license period, language, networks, exclusivity and hold backs. Business terms may be selected from the group consisting of warranty clause, text clause, payment terms, rights granted, license period, license territory, special provisions, residuals, distribution, barter window, editing rights, legal disclaimer, deal values may be selected from the group consisting of title details, versions, title attributes, notifications, contributors, options, tracking events and rights. Deliverables may be selected from the group consisting of marketing materials, master, master complete full screen, music cue sheet, trailer, title art, synopsis, black and white stills, promo clips, cast/crew, promotion stills, ad booklets and press book.

It should be understood that the foregoing relates to preferred embodiments of the invention and that modifications may be made without departing from the spirit and scope of the invention as set forth in the following claims.

I claim:

1. A method for managing, maximizing and clearing digital assets, said method comprising the steps of:
inputting at least one asset into a title maintenance module;
assigning at least one client value relevant to a client;
assigning rights information to each said at least one asset;
searching for at least one asset for a specific time period according to said rights information to provide programming;
searching and ensuring rights clearance according to said rights information; and
tracking actual usage of said at least one asset.

2. A method as in claim 1, further comprising the step of:
scheduling said programming.

3 A method as in claim 1, wherein said rights information is selected from the group consisting of rights, restrictions, promotional, editing, exhibition, elemental, talent, territory, license period, language, networks, exclusivity and hold backs.

4. A method as in claim 1, further comprising the step of:
inputting business terms.

5. A method as in claim 1, wherein said business terms are selected from the group consisting of warranty clause, text clause, payment terms, rights granted, license period, license territory, special provisions, residuals, distribution, barter window, editing rights, legal disclaimer.

6. A method as in claim 1, wherein said deal values are selected from the group consisting of title details, versions, title attributes, notifications, contributors, options, tracking events and rights

7. A method as in claim 1, wherein said deliverables are selected from the group consisting of marketing materials, master, master complete full screen, music cue sheet, trailer, title art, synopsis, black and white stills, promo clips, cast/crew, promotion stills, ad booklets and press book.

8. A method as in claim 1, further comprising the steps of:
inputting at least one finance asset;
inputting at least one finance liability; and
inputting at least one payment detail.

9. A method as in claim 1, further comprising the steps of:
searching for at least one asset or deal according to selected parameters to provide search results; and
exporting said search results.

10. A method as in claim 1, further comprising the steps of:
inputting at least one deal according to deal values; and
tracking the stage of each said at least one deal;

11. A method as in claim 1, further comprising the step of:
tracking at least one deliverable.

13. A method as in claim 11, wherein said deliverable is selected from the group consisting of deliverables are selected from the group consisting of marketing materials, master, master complete full screen, music cue sheet, trailer, title art, synopsis, black and white stills, promo clips, cast/crew, promotion stills, ad booklets and press book.

14. A method as in claim 4, further comprising the step of:
expensing elements according to said business terms.

15. A method as in claim 4, further comprising the step of:
amortizing assets according to said business terms.

16. A method as in claim 4, further comprising the step of:
making a payment according to said business terms.

17. A method as in claim 1, further comprising the steps of:
searching for underutilized assets;
providing a list of said underutilized assets; and
determining a list of potential licensees for said underutilized assets.

18. A system for managing, maximizing and clearing digital assets, said system comprising:
an acquisitions module containing asset information associated with at least one digital asset;
a development module, wherein said development module tracks and manages said at least one digital asset;
a finance module;
a distribution module, wherein said distribution module manage content rights associated with said at least one digital asset; and
a program planning module.

19. A system as in claim 18, further comprising an enterprise performance management module, wherein said enterprise performance management modules provides operations and performance information.

20. A system as in claim 18, wherein said acquisitions module tracks and manages holdbacks, exclusives, and all other title right details.

21. A system as in claim 18, wherein said asset information includes rights information, business terms and deal values.

22. A method as in claim 21, wherein said business terms are selected from the group consisting of warranty clause, text clause, payment terms, delivery information, rights granted, license period, license territory, special provisions, residuals, distribution, barter window editing rights, legal disclaimer.

23. A method as in claim 21, wherein said deal values are selected from the group consisting of title details, versions, title attributes, approval requests, notifications, contributors, options, tracking events and rights.

24. A system as in claim 18, wherein said rights information is selected from the group consisting of rights, restrictions, promotional, editing, exhibition, elemental, talent, territory, license period, language, networks, exclusivity and hold backs, wherein said development module ensures compliance and payment obligations.

25. A system as in claim 18, wherein said development module automatically generates contracts using standard business terms and templates.

26. A system as in claim 18, wherein said development module generates a rights bible.

27. A system as in claim 18, wherein said development module schedules milestones by calendar or event.

28. A system as in claim 18, wherein said distribution module generates contracts.

29. A system as in claim 18, wherein said distribution module tracks and manages distribution deals for said at least one digital asset.

30. A system as in claim 18, wherein said distribution module tracks and manages title rights for said at least one digital asset.

31. A system as in claim 18, wherein said distribution module generates a list of at least one underutilized asset.

32. A system as in claim 18, wherein said finance module tracks and manages at least one payment associated with said at least one digital asset.

33. A system as in claim 18, wherein said finance module configures amortization rules-based schedules.

34. A system as in claim 18, wherein said finance module integrates with at least one third party financial system to permit financial forecasting.

35. A system as in claim 18, wherein said program planning module creates at least one program schedule containing at least two digital assets according to said asset information.

36. A system as in claim 35, wherein said at least one program schedule is according to maximized ratings and lower cost.

37. A system as in claim 18, wherein said program planning module validates exhibition and territorial rights in real time.

38. A system as in claim 18, wherein said program planning module manages ancillary content.

39. A system as in claim 38, wherein said ancillary content is selected from the group consisting of MPAA ratings, script synopsis and cast.

40. A system as in claim 38, further consisting of a title maintenance module containing at least one title with title information.

41. A system as in claim 39, wherein said title information is selected from the group consisting of title ID, also known as, short name, number of episodes, network source, title source, title status, title group, title type, title format, MPAA ratings, release year, cast, genre, awards, content, holidays, standards, classes, regulations details
